(19) United States
(12) Patent Application Publication
(10) Pub. No.: US 2007/0106602 A1
(43) Pub. Date: May 10, 2007

(54) Card purchase transaction processing

(75) Inventor: Luke Wolters, Katy, TX (US)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 11/255,287

(22) Filed: Oct. 20, 2005

(51) Int. Cl. G06Q 40/00

(52) U.S. Cl. 705/39

(57) ABSTRACT

The disclosed system and method provides a way for merchants and customers to use charge cards as payment for special pre-arranged pricing. The disclosed system and method allow both the merchant and the customer additional flexibility in carrying out pre-arranged pricing schemes. Embodiments of the disclosed system and method enable charge card payments to be used for pre-arranged pricing using the same infrastructure as existing charge card payment systems, thereby reducing the costs and inconvenience to merchants and customers. In addition, embodiments of the disclosed system and method allow pre-arranged pricing transactions to be carried out in the same manner as regular charge card transactions from the perspective of the card holder and merchant. Neither the charge card holder nor the merchant need to perform any different or additional steps to affect payment at the pre-arranged price.

### FIELD OF THE INVENTION

The present disclosure relates to systems and methods for processing charge card transactions. More particularly, the present disclosure presents systems and methods for processing charge card transactions in a processor based network that enable the implementation of pre-arranged pricing for certain charge cards.

### BACKGROUND OF THE INVENTION

Processor based charge card transaction systems have existed for some time. One drawback of existing systems is that there typically is no convenient way for merchants or customers to use charge cards as payment for special pre-arranged pricing. For example, in the context of a motor vehicle fueling station, it is often preferable to provide large volume customers (e.g., bus transportation companies, trucking companies, taxi companies, and other fleet vehicle companies) with special pricing to encourage repeat business. In some scenarios, both the fleet company and the fueling station would prefer the ability to use charge cards to pay for the fuel purchased, however, doing so is difficult because existing charge card payment systems are not easily modifiable to account for any pricing discounts or incentives.

Another drawback of existing systems is that currently the burden is on the merchant and the person using the charge card to remember to request/apply the prearranged pricing. Thus, in the fleet vehicle scenario, the driver of each vehicle and/or the attendant of each station must remember to apply the prearranged pricing. In some fueling environments, accounting for prearranged pricing requires the driver to come in to the station (as opposed to paying at the pump) which can cause increased delays and inconvenience.

Other drawbacks and disadvantages also exist. For example, current processing systems typically require a fixed predetermined price at the time of the transaction. Thus, merchants and fleet operators may have difficulty arranging a discount price that could change in the future based on other events (e.g., bigger discount applied if the fleet meets certain volume purchase thresholds).

### SUMMARY OF THE INVENTION

The disclosed system and method provides a way for merchants or customers to use charge cards as payment for special pre-arranged pricing, without the need to greatly modify existing charge card payment systems, thereby reducing the costs and inconvenience to merchants and customers. Embodiments of the disclosed system and method allow pre-arranged pricing transactions to be carried out using the same infrastructure as regular charge card transactions. Neither the charge card holder nor the merchant needs to perform any different or additional steps to affect payment at the pre-arranged price.

More particularly, in accordance with some of the disclosed embodiments, there is provided a system and method that enables regular processing for some charge cards and different processing for pre-arranged pricing cards. As described more completely below, for the pre-arranged pricing cards, the transaction is not settled by the main and/or financial processor. Instead, for charge cards identified as pre-arranged pricing cards, the main and/or financial processor generates an offsetting transaction entry to net the sales value to zero. Then the main and/or financial processor sends the merchant and the card issuer a summary of all the pre-arranged pricing card transactions. The card issuer, applies the pre-arranged discount to the card transaction for the particular customer (i.e., the card holder) and bills the customer. The card issuer reimburses the merchant for the transaction at the pre-arranged price.

The herein described systems and methods enable merchants to get paid by the main or financial processor for some charge cards (e.g., regular transactions using VISA, MASTERCARD, etc.) and to get paid by the card issuer (e.g., Fleetcor) for the charge cards identified for pre-arranged pricing, even though all cards are processed using substantially the same infrastructure. Such a system and method permits merchants to give individual customer discounts, using the same processing methods (from the card holder and merchant's perspective) and the same card processing infrastructure, by coordinating customer discounts with the card issuer. Other advantages and features will be apparent from the following detailed description.

### BRIEF DESCRIPTION OF THE DRAWINGS

FIG. 1 is a schematic diagram depicting a typical infrastructure of a system for processing charge card transactions.

FIG. 2 is a schematic diagram illustrating a known method for processing regular charge card transactions utilizing the infrastructure of FIG. 1.

FIG. 3 is a schematic diagram illustrating a new method for processing pre-arranged pricing charge card transactions, in accordance with some embodiments of the disclosed invention, that also utilizes the infrastructure of FIG. 1.

FIG. 4 is a schematic flow diagram further illustrating the new method for processing pre-arranged pricing charge card transactions.

### DETAILED DESCRIPTION OF THE PREFERRED EMBODIMENTS

As disclosed herein, purchasers are described as making purchase transactions using a charge card, which is typically a plastic or similar material card having embossed alpha-numerical information relating to an account and, in most cases, has a magnetic stripe containing similar account data. As used herein, a charge card may comprise a credit card, a debit card, a stored value card, a preferred customer card, a club membership card, or any other suitable device for making a purchase without physically exchanging cash.

In addition, the disclosed system and method may also be practiced with charge cards of varying form. For example, it is possible to practice the disclosed system and method with a Radio Frequency IDentification (RFID) device (such as a key fob or other form factor) associated with a charge account. Likewise, optically encoded devices (e.g., bar-codes) or biometric readers (e.g., fingerprint readers) may also function as charge cards.

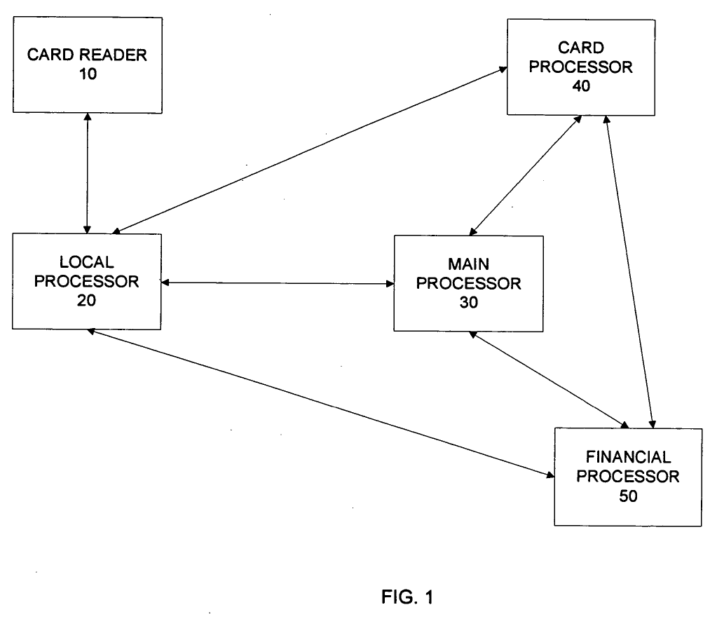

FIG. 1 is a schematic illustration of a typical system for processing purchase transactions. This particular embodiment relates to a fuel dispensing environment, but the invention is not so limited and may be practiced in other environments (e.g., retail, restaurant, on-line, etc.) as will be apparent to those skilled in the art.

As shown, the system comprises a card reader device 10 that reads or otherwise enables a purchaser to enter their card number. Any suitable mechanism for entering the card number may be used. For example, the card reader device 10 may comprise a magnetic reader that reads the data on a magnetic stripe when the card is swiped through the reader. In other embodiments, the reader may be a bar-code scanner, a manual entry key-pad, a RFID receiver or other suitable mechanism to capture the purchaser's card number.

Similarly, embodiments may differ on what number is entered or captured by the card reader device 10. In some embodiments, the number may be the charge card account number (e.g., as captured by reading a magnetic stripe). Other embodiments may capture a customer number, an RFID number, chip card number or some other identifier of the purchaser's account. In any case, one purpose of capturing the number is to identify the account to be charged for the purchase.

Card reader device 10 may comprise a stand-alone device or it may be integral with other devices. For example, in an embodiment related to fuel purchasing, card reader device 10 may comprise part of a fuel pump. In other embodiments, card reader device 10 may comprise a computer program or software module that enables entry of the card number into an on-line website. Likewise, card reader device 10 may comprise part of a cash register or other Point-Of-Sale (POS) device.

The system further comprises a local processor 20. The local processor 20 may comprise any suitable transaction processing device. For example, local processor 20 may be a backoffice P/C based system (e.g., Passport or Nucleus). Local processor 20 may also be part of a network of devices, an integral part of another device, or a stand-alone special purpose device. Among other things, the local processor 20 receives the initial data pertaining to the transaction (e.g., receives data communicated from a card reader, amount of purchase, etc.) and can either store, report or pass the data. Typically, local processor 20 is associated with the merchant location.

In some embodiments, the system may further comprise a main transaction processor 30. One function of main processor 30 is to communicate with the local processor(s) 20. For example, the main processor 30 may receive a communication from the local processor 20 containing the data from one or more purchase transactions. Other functions of the main processor 30 may include formatting the transactions and communicating with a card processor 40 and financial processor 50. Main processor 30 may also comprise a stand-alone device, a networked device, a device integrated into another device or some other configuration. For example, main processor 30 may comprise a Tandem On-Line Transaction Processor (OLTP).

However, the main processor 30 is optional. Typically, a main processor 30 is implemented in embodiments where several affiliated, or otherwise related, merchants implement a centralized payment processor. For example, a main processor 30 may be located or associated with a main office or headquarters and communicates with a plurality of local processors 20.

As noted above, the system also comprises a card processor 40. Card processor 40 comprises an entity that, among other things, approves a given transaction with a charge card. Card processor 40 may also be the issuer of the charge card (e.g., the entity that maintains the charge card account). Card processor 40 may be embodied in any suitable configuration (e.g., network device, stand-alone device, integrated device, special purpose device, etc.).

Embodiments of the system may also comprise a financial processor 50. Among other things, the financial processor 50 functions as the entity that typically enables payment of the various entities involved in the transaction or processing of the data so it can be settled both from a finding or billing perspective. For example, financial processor 50 may communicate with the card processor 40 and the main processor 30 in order to reconcile a transfer of funds from the charge account to the merchant where the charge card was presented as payment (e.g., at the local processor 20). Financial processor 50 may be embodied in any suitable configuration (e.g., network device, stand-alone device, integrated device, special purpose device, etc.).

However, the functions of the financial processor 50 may be carried out by main processor 30 and then the financial processor 50 may be eliminated from the system. Conversely, in other embodiments, it is possible to eliminate the main processor 30 and perform its functions at the financial processor 50. Other combinations or distributions of the functions performed by the main processor 30 and financial processor 50 may also be implemented.

As noted above, various processors (e.g., main processor 30, financial processor 50, card processor 40) may be used to carry out the functions described herein. As understood by those skilled in the art, the various processors may further comprise several modules to carry out the various processes. The modules may comprise software routines (e.g., programs), firmware routines, hardware components, or any other acceptable mechanism for performing processor based operations. Modules may comprise all or part of a software routine and several routines may be used to accomplish the desired functionality. In addition, it is understood that all or parts of the modules may be distributed over other networked resources.

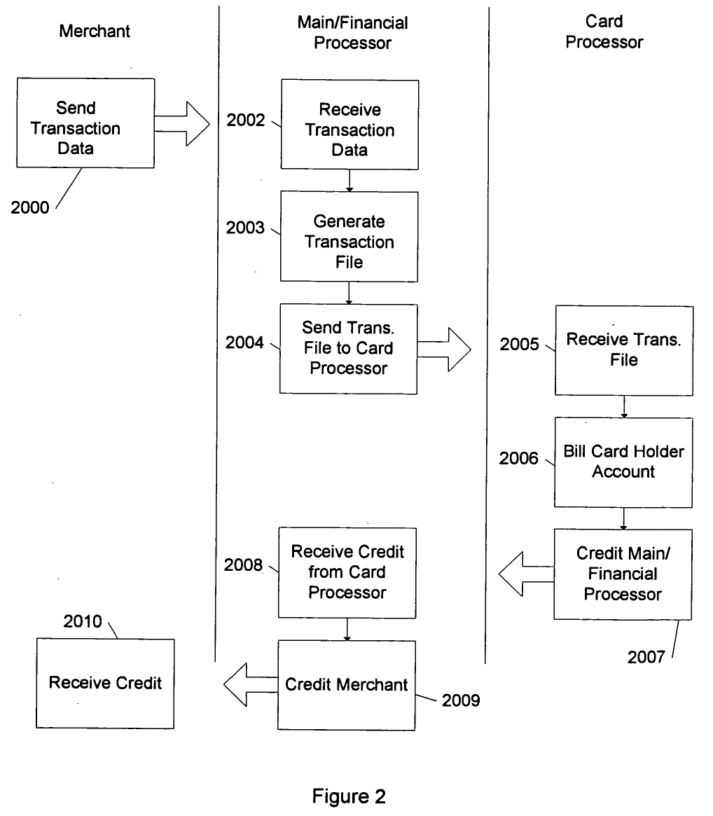

FIG. 2 is a schematic diagram illustrating a method for processing regular charge card transactions using the infrastructure in FIG. 1. As used herein “regular” means transactions for which pre-arranged pricing is not to be applied. As shown in FIG. 2, transaction processing for regular card transactions typically initiates when transaction data is sent from merchant (e.g., local processor 20) as indicated at 2000.

Transaction data may comprise any data that enables identification of the particular transaction performed with the charge card. For example, transaction data may comprise date, time and amount of purchase, merchant location, charge card account identifier (e.g., account number, account alias, RFID number, etc.), card processor information, and other information that enables identification of a transaction.

Depending on the embodiment of the system, either main processor 30 or financial processor 50 (or a combination of the two) receives the transaction data as indicated at 2002. As indicated at 2003, a transaction file is generated (again, either by main processor 30, financial processor 50, or a combination of the two). A transaction file comprises a file of transaction data. Of course, the transaction file may contain more or less data than just the transaction data. It may be in any suitable format for processing.

As indicated at 2004, the transaction file is sent to card processor 40. Card processor 40 receives the transaction file as indicated at 2005. Card processor 40 extracts sufficient information from the transaction file to generate a bill, in accordance with any card holder agreements, and send it to the card account holder as indicated at 2006.

As indicated at 2007, the card processor then credits the financial processor 50 (or main processor 30) for the amount of the transaction(s) indicated in the transaction file. Of course, transfer of the credit may occur in any acceptable method as is known in the art.

As indicated at 2008, the financial 50 and/or main 30 processor receives the credit from the card processor and applies the credit to the merchant indicated in the transaction file as shown at 2009. Again, the credit may be applied in any acceptable method as is conventional in the art. For example, step 2009 applying credit can and (and, in practice often does) happen directly as a result of sending the transaction file at step 2004, without waiting for credit to be received at step 2008. In any event, the merchant ultimately receives the credit as indicated at 2010.

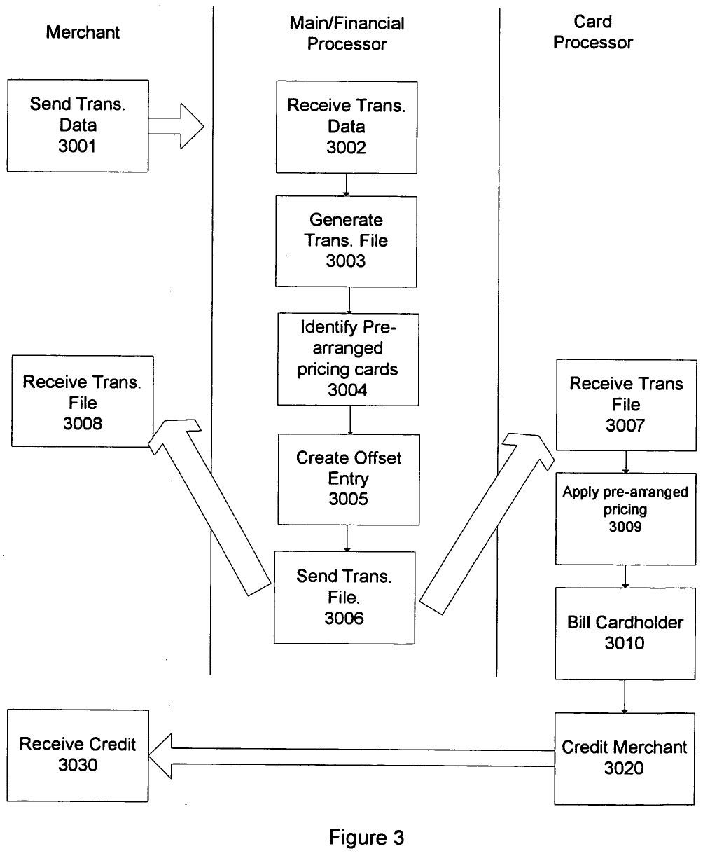

FIG. 3 is a schematic diagram illustrating the processing for pre-arranged pricing charge card transactions, in accordance with some embodiments of the disclosed methods. As shown in FIG. 3, one of the major benefits of the instant invention is that the same infrastructure, e.g., the infrastructure shown in FIG. 1, may be used for both regular and pre-arranged pricing transactions.

As indicated at 3001, the process again initiates with transaction data being sent from a merchant (local processor 20) to a main processor 30 or financial processor 50 (or combination thereof). Again, the transaction data is received, as indicated at 3002, and a transaction file is generated as indicated at 3003.

Information from the transaction file is then used to identify charge card transactions for which pre-arranged pricing is to be applied as indicated at 3004. Identification of pre-arranged pricing charge cards may be performed in any suitable manner. For example, it is known in the art that the first few digits of a charge card number typically identify the type of card being used (e.g., Visa, MasterCard, American Express, etc.). Thus, it is possible to identify the pre-arranged pricing charge cards using the first few digits of a charge card number. Other identification schemes are also possible.

Once a charge card transaction is identified as a pre-arranged pricing transaction, an offsetting transaction amount is created as indicated at 3005. The offsetting transaction amount is listed as a credit for the same amount as the transaction purchase amount (at the non-pre-arranged price). The offsetting entry nets out the transaction to zero amount due. The offsetting entry may be created by any suitable processing scheme.

As indicated at 3008 and 3007, the transaction file, including the offsetting entries is at least sent to card processor 40, and preferably sent to both the merchant (local processor 20) and card processor 40. The merchant (local processor 20) may use the transaction file for any suitable purpose, such as archiving, auditing, or other purposes.

As indicated at 3009, card processor 40 applies the pre-arranged pricing to the appropriate transactions (e.g., the properly identified cards with zero net amount due in the transaction file). The pre-arranged pricing may be applied using any suitable processing scheme.

Once the appropriate pre-arranged pricing is applied, card processor 40 extracts sufficient information from the transaction file to bill the card holder, per any card holder agreement, at the pre-arranged price amount as indicated at 3010. The card holder 40 also credits the merchant (local processor 20) for the pre-arranged amount as indicated at 3020. The merchant (local processor 20) receives the credit as indicated at 3030. Again, transfer of the credit may be performed in any conventionally acceptable manner. Notably, in this embodiment, and in contrast to FIG. 2, the credit received by the merchant (local processor 20) comes directly from card processor 40 rather through an intermediary, such as main processor 30 or financial processor 50.

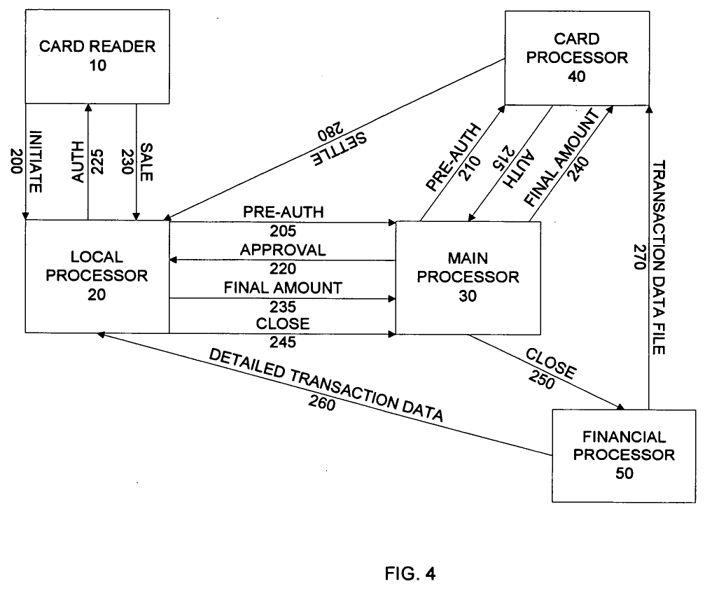

FIG. 4 is a flow diagram further illustrating the method of processing pre-arranged charge card transactions. As described herein, the method is demonstrated in the context of a retail fueling environment, however, the invention is not so limited and other charge card transactions may be processed using the disclosed method.

As shown, the process initiates as indicated at 200 when a customer initiates a charge card transaction. In the fueling environment, initiation may occur when a customer swipes a charge card through an appropriate reader on a fueling pump. Other types of initiation are also possible.

One characteristic of some fueling environments is that the goods (i.e., the fuel) may be pumped into the customer's vehicle prior to a final amount being known. In such a case, authorization to pump fuel may be given based on a preliminary authorization amount. For example, as indicated at 205, upon initiation 200 an authorization request, based upon a preliminary amount (e.g., set to a typical default purchase amount), may be forwarded from local processor 20 to main processor 30. Main processor 30 may, in turn, forward the authorization request to card processor 40, as indicated at 210, for authorization to purchase up to the preliminary amount.

As indicated at 215, card processor 40 may return an approval. Of course, card processor 40 may return something other than an approval if conditions so warrant. For example, if the charge card has been reported as stolen, card processor 40 may return a denial of authorization. Similarly, card processor 40 may return a revised authorization amount based upon current available charge card account balances.

As indicated at 220, the approval (or denial) from card processor 40 is returned to the local processor 20. Based upon the approval, the local processor 20 may enable the customer to pump fuel as indicated at 225. Of course, if a denial is returned, the local processor 20 will prevent the customer from pumping fuel or, in the case of a returned available credit limit, only allow fuel to be dispensed up to the returned available credit limit.

As should be apparent, these pre-authorization steps may be omitted from embodiments that do not rely upon delivery of goods or performance of services prior to payment. Alternatively, pre-authorization may be accomplished using a different scheme (e.g., a blanket authorization for amounts under a certain cap, etc.).

When a customer has finished dispensing fuel, transaction details, such as the final purchase amount, will be known. Typically in the fueling environment, the final purchase amount is the amount that is displayed on the fuel pump and does not account for any discounts or special prices that the customer may receive. These transaction details are communicated to local processor 20 as indicated at 230 and then relayed to main processor 30 as indicated at 235.

As indicated at 240, this final purchase information may be relayed to card processor 40 and also to Financial Processor 50 in a close-out indicated at 250. In some embodiments, relaying of final purchase information to card processor 40 may occur in a relatively immediate fashion prior to batch close-out or other end-of-the-day processing. One advantage of this timely reporting of each transaction is that it enables card processor 40 to update the charge card account in a correspondingly timely fashion which allows the card customer to view purchase transactions prior to settlement for internal reporting, cash flow requirements, driver tracking or vehicle tracking.

As indicated at 245, when normal close-out procedures are performed (e.g., at the end of the business day), the transaction data is again transmitted to the main processor 30 in the batch of daily sales data transmitted from the local processor 20. Those batch transactions are transmitted to financial processor 50 in the normal manner as indicated at 250.

For the charge card accounts that have been identified as pre-arranged pricing card accounts, the financial processor 50 creates an offsetting entry for the corresponding charge card account for the same initial purchase amount of the sale as indicated at 260. Both the original sale value and offsetting entry are passed in 260. The transaction data may comprise the date and card number (or other account identifier) for the transaction as well as the initial amount of the purchase. In some embodiments, a transaction number may be included in the transaction data.

In some embodiments, the financial processor 50, may also create a transaction data file and report it to the card processor 40 as indicated at 270. The transaction file may comprise an indicator that the card processor was sent an amount equivalent to the amount indicated in the final purchase amount transmitted at 235.

As indicated at 280, the card processor now settles with the local processor 20. The card processor 40 may apply any previously arranged discounts or price incentives and settle with the local processor 20 for that previously arranged amount. Typically, the prearranged settlement amount paid as indicated at 280 is less than the final purchase amount communicated at 235 as the card processor's customers are usually offered a discount or other incentive. Of course, any arrangement (e.g., a rewards program) can be made between card processor 40 and local processor 20 and the invention is not limited to discounts.

In the above described manner a local processor 20 and card processor 40 are able to arrange and implement a special pricing scheme or other rewards or incentive programs with minimal need for changing existing payment systems and routines, processor 20 can use existing equipment to facilitate the purchases, can vary the price by specific customer and can provide customer based incentives to purchase. Likewise, the financial processor 50 experiences minimal changes to existing processing routines. Customers can negotiate with specific retailers, get information on transactions in real time which can be used for fleet management, funding management, etc.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

What is claimed is:

1. A method for processing a charge card transaction comprising:
(i) receiving transaction data comprising a charge card identifier;
(ii) creating a transaction file comprising at least some of the transaction data and identifying transaction data for a pre-arranged pricing charge card;
(iii) creating an offsetting transaction entry in the transaction file for transaction data identified as for the pre-arranged pricing charge card; and
(iv) communicating the transaction file to a card processor so that the card processor is able to apply pre-arranged pricing to the transaction data identified as for the pre-arranged pricing charge card.

2. The method of claim 1 wherein the transaction data comprises a final purchase amount.

3. The method of claim 2 wherein the offsetting transaction entry further comprises a credit for the final purchase amount.

4. The method of claim 1 wherein the transaction data further comprises a transaction number.

5. A method for processing a charge card transaction comprising the following steps:
(i) a merchant sends transaction data comprising a charge card identifier to a first processor;
(ii) the first processor (a) receives the transaction data, (b) creates a transaction file comprising at least some of the received transaction data, (c) identifies transaction data for a pre-arranged pricing charge card, (d) creates an offsetting transaction entry in the transaction file for transaction data identified as for the pre-arranged pricing charge card and (e) communicates the transaction file to a second processor;
(iii) the second processor applies pre-arranged pricing to the transaction data identified for the pre-arranged pricing charge card and credits the merchant for an amount consistent with the applied pre-arranged pricing; and
(iv) the merchant receives the credit for the amount consistent with the applied pre-arranged pricing.

6. The method of claim 5 wherein the transaction data comprises a final purchase amount.

7. The method of claim 6 wherein applying pre-arranged pricing further comprises discounting the final purchase amount to an amount that is less than the final purchase amount.

8. A system for processing a charge card transaction comprising:
(i) a transaction data receiving module for receiving transaction data comprising a charge card identifier;
(ii) a transaction file creation module for creating a transaction file comprising at least some of the received transaction data;
(iii) an identification module for identifying transaction data for pre-arranged pricing charge cards;
(iv) an offsetting transaction creation module for creating an offsetting transaction entry in the transaction file for transaction data identified as for pre-arranged pricing charge cards;
(v) a communication module for communicating the transaction file to a card processor so that the card processor is able to apply pre-arranged pricing to transaction data identified as for a pre-arranged pricing charge card.

9. The system of claim 8 wherein the transaction data comprises a final purchase amount.

10. The system of claim 9 wherein the offsetting transaction entry further comprises a credit for the final purchase amount.

11. The system of claim 8 wherein the transaction data further comprises a transaction number.

12. A system for processing a charge card transaction comprising:
(i) a transaction data module enabling a merchant to send transaction data comprising a charge card identifier to a first processor;
(ii) a receiving module for receiving the transaction data at the first processor;
(iii) a transaction file creation module for creating a transaction file comprising at least some of the received transaction data;
(iv) an identification module for identifying transaction data for pre-arranged pricing charge cards;
(v) an offsetting transaction creation module for creating an offsetting transaction entry in the transaction file for transaction data for pre-arranged pricing charge cards;
(vi) a communication module for communicating the transaction file to a second processor;
(vii) a pre-arranged pricing module enabling the second processor to apply pre-arranged pricing to transaction data identified as for a pre-arranged pricing charge card;
(viii) a credit module enabling the second processor to credit the merchant for an amount consistent with the applied pre-arranged pricing;
(ix) a credit receiving module enabling the merchant to receive the credit for the amount consistent with the applied pre-arranged pricing.

13. The system of claim 12 wherein the transaction data comprises a final purchase amount.

14. The system of claim 13 wherein the pre-arranged pricing module further comprises a discounting module for discounting the final purchase amount to an amount that is less than the
